(19) United States
(12) Patent Application Publication
(10) Pub. No.: US 2014/0222788 A1
(43) Pub. Date: Aug. 7, 2014

(54) RESEARCH RECOMMENDATION SYSTEM

(71) Applicants: David C. Noelle, Merced, CA (US); Donald A. Barclay, Merced, CA (US)

(72) Inventors: David C. Noelle, Merced, CA (US); Donald A. Barclay, Merced, CA (US)

(73) Assignee: The Regents of the University of California, Oakland, CA (US)

(21) Appl. No.: 14/240,326

(22) PCT Filed: Aug. 23, 2012
(86) PCT No.: PCT/US2012/052111

§ 371 Date: Feb. 21, 2014

Related U.S. Application Data
(60) Provisional application No. 61/527,047, filed on Aug. 24, 2011.

(51) Int. Cl. G06F 17/30

(52) U.S. Cl. CPC G06F 17/30424
USPC 707/722

(57) ABSTRACT

Disclosed are computer-implemented methods for identifying, in a database, a search result comprising information that is relevant to a search query comprising a course identifier, wherein the database comprises relations between the course identifier and information relevant to the course. Computer program products and systems for carrying out the methods are also provided.

### CROSS REFERENCE TO RELATED APPLICATIONS

This application claims the benefit under 35 U.S.C. §119(e) of U.S. Provisional Applications Ser. No. 61/527,047 filed Aug. 24, 2011, the content of which is incorporated by reference in its entirety into the present disclosure.

### FIELD OF THE DISCLOSURE

The present disclosure generally relates to systems and methods of assisting students to conduct academic research.

### BACKGROUND

Research projects conducted by inexperienced researchers such as undergraduate students are frequently driven by the need to fulfill the requirements of specific assignments generated from within the framework of formal course curricula.

The conventional approach to conduct literature research with all print-format and digital information-discovery tools is to use the subject being researched as the primary access point for discovery. With such discovery tools users are expected to enter subject headings or keywords in order to retrieve relevant information. This emphasis on subject reflects the historical fact that in a print-format library of any size, organizing information by subject is the most logical and effective approach.

Undergraduate students, however, are generally unfamiliar with the vocabulary and organizational concepts of the literature they are searching. In particular, because undergraduate students typically do not know the precise language of the topic being researched, their researches are ineffective. As a result, an overwhelming amount of information is retrieved that is neither scholarly nor relevant while, at the same time, the best and most relevant items from the information resources remain undiscovered.

Previously, this problem was addressed, ineffectively by providing one-on-one human assistance in the form of reference librarians. The disadvantages of the above approaches are that they are 1) costly because they rely on high-priced human labor and 2) ineffective because they are either not available at the exact point/time of need and/or require a level of subject knowledge that undergraduates rarely possess.

### SUMMARY

The present disclosure provides systems and methods for assisting students conduct academic research. The present technology supports undergraduate research efforts by recommending specific electronic publication databases, and by facilitating novice-level use of those databases. In one aspect, the system recommends broad publication databases, or together with specific documents, rather than specific documents alone, in response to user queries.

Thus, in one embodiment, the present disclosure provides a computer program product comprising a computer-readable non-transitory medium containing executable program code that, when executed, identifies, in a database, a search result comprising information that is relevant to a search query comprising a course identifier and a keyword, wherein the database comprises relations between the course identifier and information relevant to the course.

Also provided is a computer-implemented method comprising identifying, in a database, a search result comprising information that is relevant to a search query comprising a course identifier and a keyword, wherein the database comprises relations between the course identifier and information relevant to the course.

In some embodiments, the search query further comprises a course assignment identifier.

In one embodiment, the database further comprises relations between the course assignment identifier and information relevant to the course assignment.

In another embodiment, the course identifier comprises one or more of a course identification number, a course number, a course name or a professor's name.

In any of the above embodiments, the database comprises one or more of articles, journals, books, subjects, keywords, classifications and sub-databases. In one aspect, the information relevant to the course comprises one or more of articles, journals, books, subjects, keywords, classifications and sub-databases that are relevant to the course. In another aspect, the search result comprises one or more sub-databases relevant to the search query. In yet another aspect, the search result comprises one or more subjects or keywords relevant to the search query.

In certain embodiments, the database comprises relations extracted from a syllabus or a list of reading assignment of the course which enables conversion of a course or assignment identifier to related topics or journals shown on the syllabus and/or reading assignment.

The product can further comprise, and the method can further comprise executable program code, that when executed, determines whether the search query includes a course identifier. In one aspect, further included is executable program code when executed, saving the search query in the database. Still further in one aspect, further included is executable program code when executed, receiving the search query from a user. Yet further in another aspect, further included is executable program code when executed, displaying the search result on a webpage. In another aspect, further included is executable program code when executed, saving, within the search result, information the user selects to retrieve.

### DETAILED DESCRIPTION

Throughout this disclosure, various publications, patents and published patent specifications are referenced by an identifying citation. The disclosures of these publications, patents and published patent specifications are hereby incorporated by reference in their entirety into the present disclosure.

As used herein, certain terms have the following defined meanings Terms that are not defined have their art recognized meanings.

As used in the specification and claims, the singular form “a”, “an” and “the” include plural references unless the context clearly dictates otherwise.

As used herein, the term “comprising” is intended to mean that the compositions and methods include the recited elements, but not excluding others. “Consisting essentially of” when used to define compositions and methods, shall mean excluding other elements that would materially affect the basic and novel characteristics of the claimed invention. “Consisting of” shall mean excluding any element, step, or ingredient not specified in the claim. Embodiments defined by each of these transition terms are within the scope of this disclosure.

A “search query” refers to a text string that a user enters into a search engine in order to retrieve related information. A search query can include one or more words, numbers, special characters, or the combinations thereof.

A “database” refers to an organized collection of data in digital form. In one aspect, the data are organized to model relevant aspects of reality in a way that supports processes requiring this information. A “sub-database” refers to part of a database or an identifier in a database that points to another database.

A “course” refers to a unit of teaching that typically lasts one academic term. In one aspect, a course is led by one or more instructors, while in another aspect, it can be self-taught or taught by a virtual instructor, such as a computer-simulated instructor. It is to be appreciated that the term course is not limited to those in an undergraduate setting.

A “course assignment” refers to a study or research task which, when performed, furthers the objective of the course. It is typically assigned by an instructor, but can come from other sources such as in the text book.

A “keyword” refers to a text string that serves as a key, as to the meaning of another word, a sentence, a passage, an article, a journal, a research topic, a database, or the like.

“Classification” refers to a system of coding and organizing materials (books, serials, audiovisual materials, computer files, maps, manuscripts, realia), or more generally, knowledge, according to their subject and allocating a call number to that information resource.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

### Modes For Carrying Out The Technology

The present technology provides systems and methods that can use a managed knowledge base, e.g., a locally managed knowledge database, coupled with machine learning methods to increase the success of students, in such as undergraduate students, as they attempt to discover and access information resources needed to complete scholarly research projects related to their coursework.

The systems and methods use both expert knowledge and knowledge acquired using machine learning techniques to guide the research activities of students who are unfamiliar with 1) effective searching techniques, 2) the expert vocabulary of the subject they are researching, 3) the organization of scholarly literature, or 4) any combination of the above.

While support for class-related research projects is one objective of the present technology, the systems and methods also provide assistance to students conducting independent research. Ultimately, use of this system can contribute to the education of undergraduates more directly by communicating the range and utility of information resources available by a plurality of providers, e.g., library databases and other information providers. In this respect, the systems and methods of the present disclosure provide a tool that both increases discovering and accessing information resources while simultaneous improving students' information literacy by teaching students about information resources as they use them.

Further, because undergraduates are generally unfamiliar with the vocabulary and organizational concepts of the literatures that they are searching, the systems enhance information discovery and access by leveraging a piece of information virtually all undergraduates do know—the name or identification of the course that generated the assignment they are attempting to complete.

As described above, the conventional approach of all print-format and digital information-discovery tools is to use the subject being researched as the primary access point for discovery. With such discovery tools users are expected to enter subject headings or key words in order to retrieve relevant information. This emphasis on subject reflects the historical fact that in a print-format library of any size, organizing information by subject is the most logical and effective approach. However, undergraduates typically do not know the precise language of the discipline they are researching and therefore do not conduct effective searches, often retrieving overwhelming amounts of information that is neither scholarly nor relevant while, at the same time, failing to retrieve the best and most relevant items from the total information resources at their disposal.

Rather than relying on the subject of the research project, the systems and methods of the present disclosure use the specific course that generated the research assignment as the primary access point to information sources. Since the present technology uses its knowledge base to focus on information that is relevant to a particular course, it significantly narrows the information universe in which the user searches, providing the user with highly focused, and therefore relevant, information resources (databases, books, articles, etc.) from which to choose.

In one embodiment, the present disclosure provides a computer-implemented method comprising identifying, in a database, a search result comprising information that is relevant to a search query comprising a course identifier, wherein the database comprises relations between the course identifier and information relevant to the course.

In one embodiment, the search query includes information about the educational context, such as a course identifier. A course identifier, in one aspect, is the course name (e.g., Data Structure) or the course number (e.g., COMP101). Optionally, the identification further includes the school term (e.g., Fall 2011), the class session (e.g., Day01), and/or the instructor's name (e.g., Prof. Jones). In some embodiments, the search query further includes a course assignment identifier, such as an assignment number or title.

This course and/or assignment-based information can then be optionally combined with a text query, provided by the user. The text, for instance, can be a keyword. The user may not be familiar with the subject of the course or the assignment, and thus is not effective in picking the right keyword. Due to the inclusion of the course identification, however, the requirement for selection of the right keyword is loosened. In this respect, therefore, the user can simply pick a word from the title of the course or assignment or from the reading assignment or textbook.

Search with the systems and methods of the present technology can lead to relevant search results due to the structure and content of the database. In one aspect, the database includes relations between the course identifier and information relevant to the course. For example, such relations can be in the form of a table that matches course identifications to subjects, knowledge databases, articles, journals, books, subjects, keywords, classifications and sub-databases, or any classification of knowledge. In one aspect, the database includes relations between a course and its syllabus or a list of reading assignment of the course, which information can be used in combination with the search query to improve search quality.

The search can be initiated by a student entering a search query that includes a course identifier at a search interface. In some embodiments, the search query can further include a keyword. As used herein, a “keyword” intends to mean any string that the user deems useful in retrieving relevant information. In one embodiment, the keyword is different from the course identifier or the course name. In some embodiments, the search query further includes class information, course assignment information, professor's name and/or textbook's title etc.

Upon entry of the search query, the system can capture the course identifier. A course identifier in a school typically has a specific format, such as “HIS301”. By examining the format of the strings in a search query, therefore, the system can distinguish course identifiers from those strings that are not. Alternatively, the system already includes an exhaustive list of course identifiers, therefore any string in a search query that matches the list can be easily identified.

Once the course identifier is determined, the system can then retrieve search criteria applicable to the course. The search criteria can, for example, include database categories, sub-databases, list of journals etc. Therefore, within the system, the search query entered by the student is converted to a much more comprehensive search. If a keyword is also entered by the student, such keyword will then be combined with all search criteria determined by the course identifier to perform the search.

In the event the search query also includes other information, such as assignment number, such other information may also be converted, within the system, into additional search criteria to further enhance the search.

In one embodiment, the search result includes ranked recommendations of electronic document databases and other information resources available to the user. The ranked results, in some aspects, are to be provided in a manner that facilitates subsequent access to the recommended databases.

In order to make such recommendations, the database can be initially minimally populated but further enhanced with the searches it carries out. The database can make use of educational context (e.g., course-identity information) when making recommendations is to be recorded in a modular database, the knowledge base, and this knowledge is to take the form of relatively simple recommendation rules, encoded either with a symbolic logic or, to capture graded levels of uncertainty, with Bayesian belief networks. This knowledge base is to be minimally populated with relevant information from the campus course catalog. The system will include tools that support the easy updating and modification of this knowledge base as course offerings change. Additional data populating the knowledge base might include course syllabi, faculty reading lists, etc., or alternatively, much of this data will be provided by spiders that routinely crawl the campus web site, course management system, and other relevant sources of potential data about undergraduate courses.

Furthermore, teaching faculty and campus librarians will be allowed by the system to manually add data to the knowledge base. For example, an instructor can manually impose limits on the date (e.g., nothing more than ten years old), source (e.g., books and journals only), authority (e.g., peer-reviewed only), or approach (e.g., empirical studies only) of the information retrieved for the students.

In one embodiment, the search result includes recommendation of articles, journals, books, subjects, keywords, classifications or sub-databases relevant to the search query. In a particular aspect, the search result includes ranked recommendation of sub-databases for the user to focus on in subsequent more focused searches. In another aspect, the search result includes one or more subjects or keywords relevant to the search query.

Such recommendation can then be used in subsequent searches. For instance, in a subsequent search, the user can use a keyword recommended by the system. In another aspect, the user can directly selected a recommended sub-database in which a subsequent search is conducted. In yet another aspect, along with the recommendation, the search result automatically includes relevant information identified from the database based on such recommendation such that no subsequent search is required.

It is contemplated that the systems and methods of the present technology are suitable for both searches that include course identification in search queries and searches that do not, such as subsequent searches as described above. In this respect, the system is further configured to determine whether the search query includes a course identifier. In the event course identification is not included, a conventional search is carried out.

Further, in one aspect, the system is to be instrumented to generate and store anonymized query transaction records in a separate database. Accordingly, previously presented search queries, including the specified educational contexts, can be analyzed using machine learning methods to improve and expand upon the recommendations made by the system. Thus, in one aspect, systems and methods include executable program code when executed, saving the search query in the database.

In another aspect, the systems and methods save, within the search result, information the user selects to retrieve. When presented with a ranked recommendation of information, the user can use the user's own judgment to determine how to proceed with the subsequent searches, by clicking on the most relevant sub-database or selecting the most relevant keyword. Such selection can then used to fine tune the database to improve future search.

The present technology is designed to recommend broad publication databases in response to user queries. On the front end, the search can be integrated into a web site, catalog, course-management system, and other web-accessible resource so that it is discoverable by undergraduates and continuously available to them at their exact time of need. Once undergraduates identify the course for which they are doing research, the system will recommend databases and other information resources.

In some embodiments, the search is integrated into a specific course page within a course management system, and thus students will not need to identify their course, as the search will automatically focus on results relevant to that specific course. In this respect, the user's search query does not include the course identification, but the search itself is tailored for conduct search for a specific course, and therefore the course identification can be said to be an automatic input of the search, without user input.

### Computing Devices of the Present Technology

It will be appreciated by the knowledgeable reader that systems and methods of the present disclosure can be implemented on any computer network. In some aspect, information exchange over the computer network is carried out through secure data communication. Methods and devices for providing secure data communication are well known in the art.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A computer program product comprising a computer-readable non-transitory medium containing executable program code that, when executed, receives a search query comprising a course identifier and a keyword, conducts a search in a database that comprises one or more course identifiers, subjects of courses identified with the course identifiers, publications associated with the subjects and one or more keywords, and publication databases associated with the subjects, and displays a search result comprising a recommended publication database associated with the subject of the course identified with the course identifier and a publication associated with the subject and the keyword.

2. A computer-implemented method comprising receiving, at a computer, a search query comprising a course identifier and a keyword, conducting a search in a database that comprises one or more course identifiers, subjects of courses identified with the course identifiers, publications associated with the subjects and one or more keywords, and publication databases associated with the subjects, and displaying a search result comprising a recommended publication database associated with the subject of the course identified with the course identifier and a publication associated with the subject and the keyword.

3. The product of claim 1, wherein the search query further comprises a course assignment identifier and wherein the database further comprises relations between the course assignment identifier and information relevant to the course assignment.

4. (canceled)

5. The product of claim 1, wherein the course identifier comprises one or more of a course identification number, a course number, a course name or a professor's name.

6. The product of claim 1, wherein the database comprises one or more of articles, journals, books, subjects, keywords, classifications and sub-databases.

7. (canceled)

8. The product of claim 6, wherein the search result comprises one or more sub-databases relevant to the search query.

9. The product of claim 6, wherein the search result comprises one or more subjects or keywords relevant to the search query.

10. The product of claim 1, wherein the database comprises relations extracted from a syllabus or a list of reading assignment of the course.

11. The product of claim 1, wherein the executable program code is further configured to determine whether the search query includes a course identifier.

12. The product of claim 1, wherein the executable program code is further configured to save the search query in the database.

13-14. (canceled)

15. The product of claim 1, wherein the executable program code is further configured to save within the search result, information the user selects to retrieve.

16. A computer system comprising a processor, memory and executable program code which, when executed by the processor, receives a search query comprising a course identifier and a keyword, conducts a search in a database that comprises one or more course identifiers, subjects of courses identified with the course identifiers, publications associated with the subjects and one or more keywords, and publication databases associated with the subjects, and displays a search result comprising a recommended publication database associated with the subject of the course identified with the course identifier and a publication associated with the subject and the keyword.
